(19) United States
(12) Patent Application Publication
(10) Pub. No.: US 2024/0233699 A1
(43) Pub. Date: Jul. 11, 2024

(54) IN-VEHICLE MICROPHONE AND VEHICLE

(71) Applicant: BEIJING CO WHEELS TECHNOLOGY CO., LTD, Beijing (CN)

(72) Inventor: Daolin ZHANG, Beijing (CN)

(21) Appl. No.: 18/616,808

(22) Filed: Mar. 26, 2024

Related U.S. Application Data
(63) Continuation of application No. PCT/CN2022/121373, filed on Sep. 26, 2022.

(30) Foreign Application Priority Data
Sep. 27, 2021 (CN) 202122354757.9

(51) Int. Cl. G10K 11/00; B60R 11/00; B60R 11/02; H04R 1/02; H04R 29/00

(52) U.S. Cl. CPC G10K 11/002; B60R 11/0247; H04R 1/021; H04R 29/005; B60R 2011/0005; B60R 2011/0022; B60R 2011/0028; H04R 2499/13

(57) ABSTRACT

An in-vehicle microphone includes: a housing, a sound pickup, and a sound insulation member. The housing has an accommodating cavity, and defines a sound receiving hole in communication with the accommodating cavity. The sound pickup is arranged in the accommodating cavity. The sound insulation member surrounds at least the sound pickup, and defines a through hole in communication with the sound receiving hole.

### CROSS-REFERENCE TO RELATED APPLICATIONS

This application is a continuation of International Application No. PCT/CN2022/121373, filed on Sep. 26, 2022, which claims priority to Chinese Patent Application Serial No. 202122354757.9, filed on Sep. 27, 2021, the entire disclosures of which are incorporated herein by reference.

### FIELD

The present disclosure relates to the field of transportation tool designs, and more particularly to an in-vehicle microphone and a vehicle.

### BACKGROUND

In-vehicle microphones, as commonly used audio input devices, are generally installed in vehicles. For driving safety and comfort, Bluetooth in-vehicle hands-free systems are generally installed in the vehicles, and users may make calls through the in-vehicle microphones.

### SUMMARY

The present disclosure provides an in-vehicle microphone and a vehicle.

A first aspect of embodiments of the present disclosure provides an in-vehicle microphone, including: a housing having an accommodating cavity, the housing defining a sound receiving hole in communication with the accommodating cavity; a sound pickup arranged in the accommodating cavity; and a sound insulation member at least surrounding the sound pickup, the sound insulation member defining a through hole in communication with the sound receiving hole.

A second aspect of embodiments of the present disclosure further provides a vehicle, including a vehicle body, and an in-vehicle microphone according to any one of the above embodiments installed inside the vehicle body.

### BRIEF DESCRIPTION OF THE DRAWINGS

In order to more clearly explain the technical solution of embodiments of the present disclosure or the related art, the drawings required to be used in the description of embodiments or the related art will be briefly described below, and it is obvious that for those skilled in the art, the drawings described below are some embodiments of the present disclosure, other drawings may be obtained according to these drawings without creative labor.

FIG. 1 is a perspective schematic view of an in-vehicle microphone provided in an embodiment of the present disclosure.

FIG. 2 is an exploded schematic view of an in-vehicle microphone provided in an embodiment of the present disclosure.

FIG. 3 is a schematic view of a vehicle provided in an embodiment of the present disclosure.

FIG. 4 is a schematic view of an in-vehicle microphone array provided in an embodiment of the present disclosure.

### DETAILED DESCRIPTION

The technical solution in embodiments of the present disclosure will be clearly and completely described below in combination with the drawings in the embodiments of the present disclosure. It is apparent that the described embodiments are merely part of embodiments of the present disclosure, but not all of embodiments. Based on the embodiments in the present disclosure, all other embodiments obtained by those skilled in the art without creative work fall within the protection scope of the present disclosure.

The “include” mentioned in the description and claims is an open-ended term and should be interpreted as “include, but not limited to”. “Approximately” refers to the fact that, within the acceptable error range, those skilled in the art may solve the technical problem within a certain error range, and the technical effect is substantially achieved.

In addition, the term “connect” herein includes any direct and indirect means of connection. Therefore, if the content describes that a first device is connected to a second device, it means that the first device may be directly connected to the second device, or be indirectly connected to the second device via other devices. The subsequent description in the specification is the preferred embodiments for implementing the present disclosure, but the description is for the purpose of illustrating the general principles of the present disclosure and is not intended to limit the scope of the present disclosure. The protection scope of the present disclosure shall be subject to the definition of the appended claims.

It should be understood that the term “and/or” used herein is merely an association relationship describing the associated objects, indicating that there may be three kinds of relationships. For example, A and/or B may indicate the existence of A alone, the coexistence of A and B, and the existence of B alone. In addition, the character “/” herein generally indicates that the relationship between the associated objects before and after it is an “or” relationship.

Usually, the in-vehicle microphone is installed on a roof, an instrument panel, or other locations in the vehicle. In the process of driving, the noise around the installation location of the in-vehicle microphone is easily transmitted to the in-vehicle microphone. Therefore, how to reduce the noise transmitted into the in-vehicle microphone is an urgent problem to be solved.

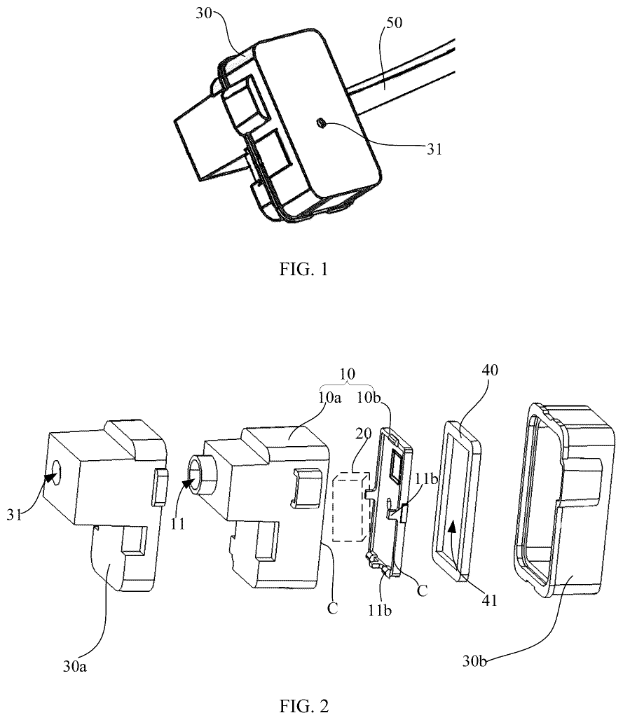

FIG. 1 is a perspective schematic view of an in-vehicle microphone provided in an embodiment of the present disclosure; FIG. 2 is an exploded schematic diagram of an in-vehicle microphone provided in an embodiment of the present disclosure. Referring to FIGS. 1 to 2, the in-vehicle microphone provided in the embodiments includes: a housing 10, a sound pickup 20, and a sound insulation member 30.

The housing 10 may be made of hard materials, such as a hard plastic, a metal, or other materials. The housing 10 has an accommodating cavity (not shown in figures), the housing 10 defines a sound receiving hole 11, and the sound receiving hole 11 is in communication with the accommodating cavity.

The sound pickup 20 is arranged in the accommodating cavity, and the sound pickup 20 is a device configured to collect the ambient sound on site and then transmit it to a back-end device. Specifically, it may include a circuit board and a microphone module. The microphone module may be a digital microphone, which converts traditional analog audio signals into digital signals for processing and transmission. The circuit board may be provided with an audio amplification circuit for amplifying the audio signals, to achieve better sound quality.

In some specific embodiments, the sound pickup 20 may be fixedly connected to the housing 10, such as, snap-fitted by a snap or detachably connected by a fastener. In some embodiments, the sound pickup 20 may also be directly tightly fitted with a cavity wall of the accommodating cavity, so that the sound pickup 20 is fastened tightly by the cavity wall of the accommodating cavity, so that the sound pickup 20 will not shake or swing in the accommodating cavity in the process of driving of the vehicle. Of course, in some embodiments, the sound pickup 20 may also be directly accommodated in the accommodating cavity of the housing 10, which is not specially limited in the present disclosure.

The sound insulation member 30 at least surrounds the sound pickup 20, and the sound insulation member 30 defines a through hole 31 in communication with the sound receiving hole 11. In some specific embodiments, the sound insulation member 30 may include but is not limited to at least one of a soft rubber, a sound-absorbing cotton, a wood wool sound-absorbing board, and a sound insulation board. The above materials have a basic sound insulation function, which may effectively block external noise from entering the sound pickup 20. In some embodiments, the sound insulation member 30 may be an elastic buffer member, for example, the sound insulation member 30 is a soft rubber. The elastic buffer member may generate a certain resistance, and isolate external vibration from being transmitted to the sound pickup 20. Therefore, on the basis of being able to isolate external noise, the risk of the sound pickup 20 picking up noise other than human voice is further reduced by isolating external vibration.

In addition, it should be noted that, the sound insulation member 30 at least surrounds the sound pickup 20, including the sound insulation member 30 only surrounding a periphery of the sound pickup 20, and also including the sound insulation member 30 surrounding the sound pickup 20 and other components.

Specifically, in some embodiments, the sound insulation member 30 may be located at an outer side of the housing 10 to surround the housing 10. Since the sound pickup 20 is arranged in the accommodating cavity of the housing 10, the sound insulation member 30 surrounds the sound pickup 20 and the housing 10 together, and only the sound insulation member 30 may be visually seen in appearance. In some examples, the in-vehicle microphone may be fixed to an internal structure of a vehicle body. For example, the sound insulation member 30 of the in-vehicle microphone is detachably connected to the internal structure of the vehicle body through a snap-fit or through a fastener such as a screw. Moreover, the internal structure of the vehicle body may be a roof, an instrument panel or other steel-stabilized internal structures. Furthermore, on basis of the sound insulation member 30 as the elastic buffer member, the elastic buffer member surrounds the entire housing 10. Therefore, when the entire in-vehicle microphone is installed in a vehicle body, the elastic buffer member is directly in contact with a wall surface of the vehicle body, for example, the elastic buffer member is in compression contact with a roof of the vehicle, which may also buffer the vibration transmitted by the roof of the vehicle to some extent, and further optimize the sound insulation effect. Moreover, since the elastic buffer member has elasticity and the elastic buffer member is connected to the wall surface of the vehicle body, under the action of a pre-tightening force of the elastic buffer member, the reliability and stability of the connection between the in-vehicle microphone overall and the vehicle body may be further improved, and it is not easy to loosen during use. A hard microphone is wrapped inside the sound insulation member 30, and only the through hole 31 in communication with the sound receiving hole 11 is reserved, which effectively reduces the input of sound generated by the vibration in the vehicle, thereby improving the signal-to-noise ratio of the in-vehicle microphone.

In some examples, a thickness of the sound insulation member 30 may be determined through the following method.

At a first step, a noise reduction amount n decibel (dB) is determined according to an algorithm requirement. The algorithm herein generally refers to a speech recognition or call algorithm. For example, the noise reduction amount n may be 10 dB, 15 dB or 20 dB. Theoretically speaking, the more noise reduction amount, the better, but the algorithm's wake-up and recognition rate is not proportional to the noise reduction amount. Assuming that the noise reduction amount is 10 dB, the wake-up and recognition rate is increased by 10%; the noise reduction amount is 15 dB, the wake-up and recognition rate is increased by 13%; the noise reduction amount is 20 dB, the wake-up and recognition rate is increased by 15% and so on. Each new vehicle model requires a redesign of the thickness of the sound insulation member based on the noise reduction amount required by the algorithm.

At a second step, the in-vehicle microphone without the sound insulation member 30 is mounted to the vehicle body and the sound receiving hole 11 is blocked, and a first noise X dB transmitted to the sound pickup 20 from the vehicle body is obtained by a road testing.

At a third step, the in-vehicle microphone having the sound insulation member 30 is mounted to the vehicle body and the sound receiving hole 11 is blocked, and a second noise Y dB transmitted to the sound pickup 20 from the vehicle body is obtained by a road testing.

At a fourth step, determine whether X−Y=n is true. If it is true, the thickness of the sound insulation member 30 satisfies the noise reduction amount requirement. If it is not true, the thickness of the sound insulation member 30 is adjusted and the third and fourth steps are continued until the thickness of the sound insulation member 30 meets the noise reduction requirement.

That is to say, the thickness of the sound insulation member 30 is determined such that a difference between the first noise and the second noise is the noise reduction amount preset by an algorithm, in which the first noise is a noise transmitted from the vehicle body to the sound pickup 20 obtained by a road testing of the in-vehicle microphone not provided with the sound insulation member 30 and with the sound receiving hole 11 blocked; and the second noise is a noise transmitted from the vehicle body to the sound pickup 20 obtained by a road testing of the in-vehicle microphone provided with the sound insulation member 30 and with the sound receiving hole 11 blocked.

In some embodiments, the sound insulation member 30 may also be directly located in the accommodating cavity, and the sound insulation member 30 surrounds the sound pickup. In some examples, the sound insulation member is located inside a hard housing and surrounds the sound pickup, and the hard housing is mounted to the internal structure of the vehicle body. In other examples, the sound insulation member surrounds the whole of the sound pickup. The internal structure of the vehicle body may be a roof, an instrument panel, or other steel-stabilized internal structure. In appearance, the entire sound insulation member 30 is surrounded by the housing 10 without being exposed. The housing 10 is directly connected and fixed to the wall surface of the vehicle body, which may also achieve noise reduction effect on the in-vehicle microphone and improve the user experience.

In the in-vehicle microphone provided in the embodiments, the sound insulation member made of sound insulation materials is arranged on the in-vehicle microphone, the sound insulation member surrounds the sound pickup, and only the sound receiving hole is exposed, which may fundamentally block the noise transmitted from the installation position of the in-vehicle microphone into the in-vehicle microphone. As a result, the voice wake-up rate and recognition rate may be effectively improved, thereby improving the user experience.

Based on the above-described, in some embodiments, the through hole 31 may be arranged directly opposite to the sound receiving hole 11, or the through hole 31 may be arranged partially opposite to the sound receiving hole 11.

It is worth noting that a cross-sectional shape of the through hole 31 in the sound insulation member 30 in the present disclosure is not limited, which may be circular, square, oval, hexagonal, or even special-shaped, etc., while a cross-sectional shape of the sound receiving hole 11 is also not limited, which may specifically be any shape mentioned above or other shapes. Moreover, the cross-sectional shapes of the through hole 31 and the sound receiving hole 11 may be the same or different, as long as the air medium may pass through the sound receiving hole 11 and through hole 31.

The through hole 31 is arranged directly opposite to the sound receiving hole 11, which means that in an installation state, a central axis of the through hole 31 coincides with a central axis of the sound receiving hole 11. In this way, the expected sound receiving effect may be ensured with defining a smaller through hole 31. It may be understood that the smaller the area occupied by through hole 31 on the sound insulation member 30, the better the sound insulation function of the sound insulation member 30. Furthermore, the through hole 31 is arranged directly opposite to the sound receiving hole 11, which may ensure that a smallest through hole 31 is defined in the sound insulation member 30 to achieve better sound receiving effect.

The through hole 31 is arranged partially opposite to the sound receiving hole 11, which means that the central axis of the through hole 31 is at a certain distance from the central axis of the sound receiving hole 11, but a cross section of the through hole 31 overlaps with a cross section of the sound receiving hole 11 in axial projection, so that both the through hole 31 and the sound receiving hole 11 may communicate directly.

Regardless of the through hole 31 and the sound receiving hole 11 are arranged directly opposite or partially opposite, the air flow may be allowed to directly enter the sound pickup 20 along a shortest path, thus ensuring the better sound pickup effect and efficiency.

Of course, in some embodiments, the through hole 31 may be arranged not opposite to the sound receiving hole 11, but the through hole 31 and the sound receiving hole 11 may be communicated through the accommodating cavity of the housing 10, which may also allow external sound to enter the sound pickup 20 through the through hole 31, the accommodating cavity, and the sound receiving hole 11.

Those skilled in the art may design the relative positions of through hole 31 and the sound receiving hole 11 according to actual needs, which is not specially limited in the embodiments of the present disclosure.

In some embodiments, the sound insulation member 30 may be fitted to at least part of the outer surface of the housing 10. The sound insulation member 30 may be fitted and covered on at least part of the housing 10, and a gap between the sound insulation member 30 and the housing 10 is minimized or canceled. Therefore, while reducing the noise of the microphone, the overall volume of the microphone may be reduced, the space inside the vehicle is occupied as little as possible, and the aesthetics of the appearance is improved.

In some examples, the sound insulation member is fitted to at least a first region of the housing, and the first region of the housing is connected to the internal structure of the vehicle body through the sound insulation member. The first region is a region that meets a predetermined requirement, the predetermined requirement being that a noise value transmitted through the first region of the housing is less than noise values transmitted through other regions of the housing, when the sound insulation member is not provided.

That is to say, an outer surface of the housing 10 has a plurality of regions. By connecting different regions of the outer surface of the housing 10 directly to the internal structure of the vehicle body (i.e., without the sound insulation member 30), corresponding noise values transmitted from the vehicle body to the pickup 20 are obtained. By comparing the plurality of noise values, the region of the outer surface of the housing 10 that transmits the smallest noise value can be determined. The sound insulation member 30 may be designed with a shape and thickness based on the region of the outer surface of the housing 10 that transmits the smallest noise value, to at least fit the region of the outer surface of the housing 10 that transmits the smallest noise value, and the region of the outer surface of the housing 10 that transmits the smallest noise value is connected to the internal structure of the vehicle body through the sound insulation member 30. It could be understood that due to the fact that the region of the outer surface of the housing 10 that transmits the smallest noise value is connected to the internal structure of the vehicle body, the requirements for the noise reduction amount of the sound insulation member 30 are relatively lower, thus the thickness of the sound insulation member 30 may be smaller and the sound insulation effect of the sound insulation member may be optimized.

In the embodiments of the present disclosure, the housing 10 may include a first housing 10a and a second housing 10b, the first housing 10a may be detachably connected to the second housing 10b, and the first housing 10a is connected to the second housing 10b to define the accommodating cavity. In some embodiments, the first housing 10a may have a box shape, the second housing 10b may have a lid shape, or both the first housing 10a and the second housing 10b may have the box shape. The first housing 10a abuts against the second housing 10b, which may be detachably connected by a snap, a screw, and etc., to facilitate the removal, disassembly, and maintenance of the sound pickup 20.

Based on the housing 10 including the first housing 10a and the second housing 10b, the sound insulation member 30 may be fitted and covered on outer surfaces of the first housing 10a and the second housing 10b, to wrap the first housing 10a and the second housing 10b together, which may further ensure the stability and reliability of connection therebetween.

Continue to refer to FIG. 2, in some embodiments, the sound insulation member 30 may include a first sound insulation member 30a and a second sound insulation member 30b. The first sound insulation member 30a and the second sound insulation member 30b may abut against each other, to enclose a sound insulation cavity, and at least the sound pickup 20 is located in the sound insulation cavity. The first sound insulation member 30a and the second sound insulation member 30b abut against each other, including direct contact and butt-joint of end faces of the first sound insulation member 30a and the second sound insulation member 30b, and the first sound insulation member 30a and the second sound insulation member 30b may be tightly wrapped the housing 10 respectively, which ensures the connection tightness and sealing between the sound insulation member 30 and the housing 10.

In other embodiments, the first sound insulation member 30a and the second sound insulation member 30b may also include a lateral overlapping part therebetween, for example, the first sound insulation member 30a may be sleeved on an outer side of the second sound insulation member 30b. Since the first sound insulation member 30a is sleeved on the outer side of the second sound insulation member 30b, the first sound insulation member 30a may be fitted and in contact with the second sound insulation member 30b laterally, thereby minimizing a gap of the joint of the first sound insulation member 30a and the second sound insulation member 30b, and improving the sealing performance of the entire in-vehicle microphone.

Furthermore, the first sound insulation member 30a or the second sound insulation member 30b may wrap the joint of the first housing 10a and the second housing 10b. In some embodiments, as shown in FIG. 2, the second housing 10b has a snap 11b. The snap 11b is snapped into a corresponding slot of the first housing 10a to connect the first housing 10a and the second housing 10b. At the same time, the first housing 10a and the second housing 10b have abutment surfaces C abutting against each other, and in an abutting state, the abutting point of the abutment surfaces C forms the joint of the first housing 10a and the second housing 10b. Moreover, the first sound insulation member 30a or the second sound insulation member 30b wraps the joint of the first housing 10a and the second housing 10b, so that the joint is firmly fixed, and the gap of the joint may be sealed to a certain extent.

In some examples, a gap is formed at the joint of the first housing 10a and the second housing 10b, the first sound insulation member 30a or the second sound insulation member 30b has a lengthwise extension, and the lengthwise extension covers the gap and is crimped to the other of the first sound insulation member 30a and the second sound insulation member 30b. Thus, the first sound insulation member 30a and the second sound insulation member 30b may prevent sound from being transmitted to an interior of the in-vehicle microphone through the gap at the joint, providing a better sound insulation effect.

In the present embodiment, the first sound insulation member 30a and the second sound insulation member 30b each may be the elastic buffer member. In other embodiments, one of the first sound insulation member 30a and the second sound insulation member 30b is the elastic buffer member, and the other may be made of other sound insulation materials, such as other hard sound insulation materials, e.g., the sound insulation board. As long as one of the sound insulation members is the elastic buffer member, the sealing between the first sound insulation member 30a and the second sound insulation member 30b may be guaranteed.

In some examples, a portion of at least one of the first sound insulation member 30a and the second sound insulation member 30b rigidly connected to the vehicle body is an elastic buffer member. It could be understood that in the case where the first sound insulation member 30a is rigidly connected to the vehicle body and the second sound insulation member 30b is not rigidly connected to the vehicle body, the portion of the first sound insulation member 30a rigidly connected to the vehicle body is an elastic buffer member, and the remaining portion of the first sound insulation member 30a may be made of other sound insulation material, such as other hard sound insulation materials, e.g., the sound insulation board; in the case where the second sound insulation member 30b is rigidly connected to the vehicle body and the first sound insulation member 30a is not rigidly connected to the vehicle body, the portion of the second sound insulation member 30b rigidly connected to the vehicle body is an elastic buffer member, and the remaining portion of the second sound insulation member 30b may be made of other sound insulation materials, such as other rigid sound insulation materials, e.g., the sound insulation board; in the case where the first sound insulation member 30a and the second sound insulation member 30b are rigidly connected to the vehicle body, the portion of the first sound insulation member 30a rigidly connected to the vehicle body and the portion of the second sound insulation member 30b rigidly connected to the vehicle body are elastic buffer members, and the remaining portion of the first sound insulation member 30a and the remaining portion of the second sound insulation member 30b may be made of other sound insulation materials, such as other rigid sound insulation materials, e.g., the sound insulation board.

In some embodiments, when the second sound insulation member 30b is the elastic buffer member, the second sound insulation member 30b may wrap the joint of the first housing 10a and the second housing 10b, so that in a connected state, the deformation of the elastic buffer member may be squeezed and filled in the gap of the joint of the first housing 10a and the second housing 10b, thus ensuring the sealing between the first housing 10a and the second housing 10b.

Furthermore, a buffer layer 40 may be arranged between the first housing 10a and/or the second housing 10b and an inner wall of the sound insulation member 30. In some specific embodiments, the buffer layer 40 may be a vibration absorption pad, and its preparation material may include but is not limited to a foam, a rubber, a flexible fabric, etc. By arranging the buffer layer 40 between the first housing 10a and/or the second housing 10b and the inner wall of the sound insulation member 30, the buffer layer 40 fills a gap between the housing 10 and the sound insulation member 30, so that the housing 10 is tightly fitted with the sound insulation member 30, further improving the vibration absorption effect while ensuring sealing performance.

The buffer layer 40 shown in FIG. 2 is arranged between the second housing 10b and the second sound insulation member 30b, and the buffer layer 40 does not block the sound receiving hole 11 and the through hole 31. In other embodiments, based on the presence of the buffer layer 40 between the first housing 10a and the first sound insulation member 30a, the buffer layer 40 may have a hollow portion 41; in the installation state, the sound receiving holes 11 and the through hole 31 may be in communication with the hollow portion 41, so that the arrangement of the buffer layer 40 will not block the sound receiving hole 11 and the through hole 31, thus ensuring normal sound receiving effect.

In addition, please refer to FIG. 1, the in-vehicle microphone provided in embodiments of the present disclosure further includes a connecting wire 50, one end of the connecting wire 50 may be connected to the sound pickup 20, and the other end may be configured to connect a horn, a speaker or the like in the vehicle, so that the sound collected by the microphone may be played out through the horn or the speaker, which is convenient for users to make voice calls through external playback in the process of driving.

Embodiments of the present disclosure further provide a vehicle, including a vehicle body, and an in-vehicle microphone as the provided in the above embodiments of the present disclosure installed inside the vehicle body.

In some specific embodiments, in some application scenarios, the in-vehicle microphone may be installed on the roof of the vehicle, or on the instrument panel, or on an inner wall of the vehicle body.

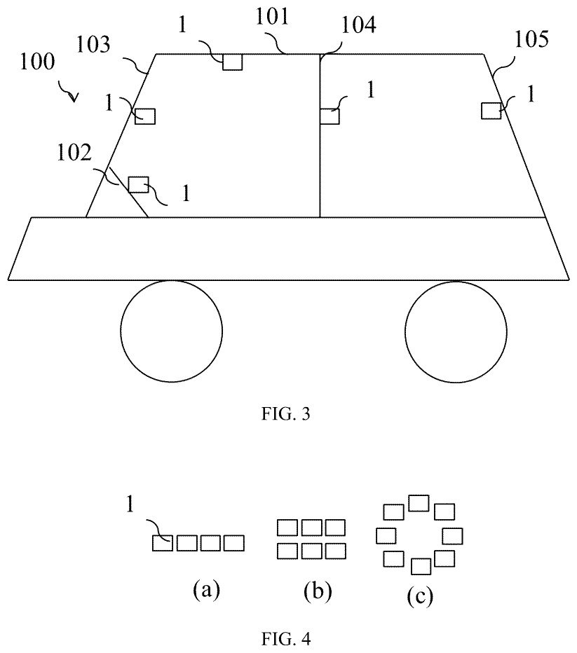

In some examples, the vehicle 100 includes a plurality of in-vehicle microphones 1, and the plurality of in-vehicle microphones 1 is arranged at least two of a roof, an instrument panel, an A-pillar, a B-pillar and a C-pillar of the vehicle body. For example, as illustrated in FIG. 3, the plurality of in-vehicle microphones 1 is arranged at each of the roof 101, the instrument panel 102, the A-pillar 103, the B-pillar 104 and the C-pillar 105 of the vehicle body.

In some examples, one in-vehicle microphone 1 is arranged at each of the at least two of the roof 101, the instrument panel 102, the A-pillar 103, the B-pillar 104, and the C-pillar 105 of the vehicle body. For example, one in-vehicle microphone 1 is arranged at each of the roof 101, the instrument panel 102, the A-pillar 103, the B-pillar 104, and the C-pillar 105 of the vehicle body.

In some examples, a plurality of in-vehicle microphones 1 is arranged at each of the at least two of the roof 101, the instrument panel 102, the A-pillar 103, the B-pillar 104, and the C-pillar 105 of the vehicle body. For example, a plurality of in-vehicle microphones 1 is arranged at each of the roof 101, the instrument panel 102, the A-pillar 103, the B-pillar 104, and the C-pillar 105 of the vehicle body.

In some examples, the plurality of in-vehicle microphones 1 at each of the at least two of the roof 101, the instrument panel 102, the A-pillar 103, the B-pillar 104, and the C-pillar 105 of the vehicle body are arranged in an array, such as, a linear array, a rectangular array, or a circular array, etc. as shown in FIG. 4.

It could be understood that the arrangement location of the in-vehicle microphones 1 is determined by different algorithms and limitations of the vehicle body.

For the in-vehicle microphones 1 in the form of an array, in order to maintain their consistency, it is necessary to ensure that each in-vehicle microphone 1 in the array meets the requirements of the algorithm for the noise reduction amount; and to ensure that the acoustic signal index (sensitivity, frequency response, phase, etc.) is consistent for each in-vehicle microphone 1 in the array.

Through the aforementioned design method of the thickness of the sound insulation member 30, it can be ensured that each in-vehicle microphone 1 in the array meets the requirements of the algorithm for the noise reduction amount, which will not be repeated here.

In order to ensure that the acoustic signal index is consistent for each in-vehicle microphone 1 in the array, a standard speaker may be placed at a position equidistant from each in-vehicle microphone 1 in the array to play a test signal (pink noise, frequency sweep), and the acoustic signal index of each in-vehicle microphone 1 in the array may be obtained. If the acoustic signal index is not consistent for each in-vehicle microphone 1 in the array, the thickness of the sound insulation member 30 of the in-vehicle microphone 1 is adjusted and further tested until the acoustic signal index is consistent for each in-vehicle microphone 1 in the array. It could be understood that the portion of the sound insulation member 30 that is adjusted to ensure that each in-vehicle microphone 1 in the array meets the requirement of the algorithm for the noise reduction amount is different from the portion of the sound insulation member 30 that is adjusted to ensure that the acoustic signal index is consistent for of each in-vehicle microphone 1 in the array. For example, in order to ensure that each in-vehicle microphone 1 in the array meets the requirements of the algorithm for the noise reduction amount, the portion of the sound insulation member 30 facing the internal structure of the vehicle body is adjusted; while in order to ensure that the acoustic signal index is consistent for each in-vehicle microphone 1 in the array, the portion of the sound insulation member 30 facing the standard speaker is adjusted, i.e., the portion of the sound insulation member 30 facing away from the internal structure of the vehicle body.

It should be noted that the structure and function of the in-vehicle microphone in the vehicle provided in the embodiments are the same as those in the above embodiments, which may specifically refer to the description of the above embodiments for details, and will not be repeated in the embodiments.

Embodiments of the present disclosure provide an in-vehicle microphone, including: a housing having an accommodating cavity, the housing defining a sound receiving hole in communication with the accommodating cavity; a sound pickup arranged in the accommodating cavity; and a sound insulation member at least surrounding the sound pickup, the sound insulation member defining a through hole in communication with the sound receiving hole.

In some embodiments, the through hole is arranged directly opposite to the sound receiving hole, or the through hole is arranged partially opposite to the sound receiving hole.

In some embodiments, the sound insulation member is located at an outer side of the housing to surround the housing.

In some embodiments, the sound insulation member is located in the accommodating cavity, and the sound insulation member surrounds the sound pickup.

In some embodiments, the sound insulation member is fitted to at least part of an outer surface of the housing.

In some embodiments, the sound insulation member comprises a first sound insulation member and a second sound insulation member, the first sound insulation member and the second sound insulation member abut against each other to enclose a sound insulation cavity, and at least the sound pickup is located in the sound insulation cavity.

In some embodiments, at least one of the first sound insulation member and the second sound insulation member is an elastic buffer member.

In some embodiments, the housing comprises a first housing and a second housing, the first housing is detachably connected to the second housing, and the first housing is connected to the second housing to define the accommodating cavity.

In some embodiments, the first sound insulation member or the second sound insulation member wraps a joint of the first housing and the second housing.

In some embodiments, a buffer layer is arranged between the first housing and/or the second housing and an inner wall of the sound insulation member.

Another aspect of embodiments of the present disclosure further provides a vehicle, including a vehicle body, and an in-vehicle microphone according to any one of the above embodiments installed inside the vehicle body.

It should be noted that, without contradiction, those skilled in the art may combine and unite different embodiments or examples or features of the different embodiments or examples described in this specification.

Finally, it should be noted that the above embodiments are only used to illustrate the technical solution of the present disclosure but not to limit; although the present disclosure has be explained in detail with reference to the aforementioned embodiments, those skilled in the art should understand that they may still modify the technical solutions mentioned in the aforementioned embodiments, or equivalently replace part of the technical features thereof; and these modifications or replacements do not make the essence of the corresponding technical solutions deviate from the spirit and scope of the technical solutions in the embodiment of the present disclosure.

All embodiments of the present disclosure may be implemented independently or in combination with other embodiments, which are all regarded as the scope of protection required by the present disclosure.

What is claimed is:

1. An in-vehicle microphone, comprising:
a housing having an accommodating cavity, the housing defining a sound receiving hole in communication with the accommodating cavity;
a sound pickup arranged in the accommodating cavity; and
a sound insulation member at least surrounding the sound pickup, the sound insulation member defining a through hole in communication with the sound receiving hole.

2. The in-vehicle microphone according to claim 1, wherein the through hole is arranged directly opposite to the sound receiving hole, or the through hole is arranged partially opposite to the sound receiving hole.

3. The in-vehicle microphone according to claim 1, wherein the sound insulation member is located at an outer side of the housing to surround the housing.

4. The in-vehicle microphone according to claim 3, wherein the sound insulation member is detachably connected to an internal structure of a vehicle body through a snap-fit or through a fastener.

5. The in-vehicle microphone according to claim 3, wherein a thickness of the sound insulation member is determined such that a difference between a first noise and a second noise is a noise reduction amount preset by an algorithm, wherein the first noise is a noise transmitted from a vehicle body to the sound pickup obtained by a road testing of the in-vehicle microphone not provided with the sound insulation member and with the sound receiving hole blocked; and the second noise is a noise transmitted from the vehicle body to the sound pickup obtained by a road testing of the in-vehicle microphone provided with the sound insulation member and with the sound receiving hole blocked.

6. The in-vehicle microphone according to claim 1, wherein the sound insulation member is located in the accommodating cavity, and the sound insulation member surrounds the sound pickup.

7. The in-vehicle microphone according to claim 6, wherein the sound insulation member is located inside a hard housing and surrounds the sound pickup, and the hard housing is mounted to an internal structure of a vehicle body.

8. The in-vehicle microphone according to claim 1, wherein the sound insulation member is fitted to at least part of an outer surface of the housing.

9. The in-vehicle microphone according to claim 8, wherein the sound insulation member is fitted to at least a first region of the housing, and the first region of the housing is connected to an internal structure of a vehicle body through the sound insulation member; and
wherein the first region is a region that meets a predetermined requirement, and the predetermined requirement is that a noise value transmitted through the first region of the housing is less than noise values transmitted through other regions of the housing, when the sound insulation member is not provided.

10. The in-vehicle microphone according to claim 1, wherein the sound insulation member comprises a first sound insulation member and a second sound insulation member, the first sound insulation member and the second sound insulation member abut against each other to enclose a sound insulation cavity, and at least the sound pickup is located in the sound insulation cavity.

11. The in-vehicle microphone according to claim 10, wherein at least one of the first sound insulation member and the second sound insulation member is an elastic buffer member.

12. The in-vehicle microphone according to claim 10, wherein a portion of at least one of the first sound insulation member and the second sound insulation member rigidly connected to a vehicle body is an elastic buffer member.

13. The in-vehicle microphone according to claim 10, wherein the housing comprises a first housing and a second housing, the first housing is detachably connected to the second housing, and the first housing is connected to the second housing to define the accommodating cavity.

14. The in-vehicle microphone according to claim 13, wherein the first sound insulation member or the second sound insulation member wraps a joint of the first housing and the second housing.

15. The in-vehicle microphone according to claim 14, wherein a gap is formed at the joint of the first housing and the second housing, the first sound insulation member or the second sound insulation member has a lengthwise extension, and the lengthwise extension covers the gap and is crimped to the other of the first sound insulation member and the second sound insulation member.

16. The in-vehicle microphone according to claim 13, wherein a buffer layer is arranged between the first housing and/or the second housing and an inner wall of the sound insulation member.

17. The in-vehicle microphone according to claim 13, wherein the sound pickup is fixedly connected to the housing.

18. A vehicle, comprising:
a vehicle body, and
one or more in-vehicle microphones installed inside the vehicle body,
wherein each of the one or more in-vehicle microphones comprises:
a housing having an accommodating cavity, the housing defining a sound receiving hole in communication with the accommodating cavity;
a sound pickup arranged in the accommodating cavity; and
a sound insulation member at least surrounding the sound pickup, the sound insulation member defining a through hole in communication with the sound receiving hole.

19. The vehicle according to claim 18, wherein the one or more in-vehicle microphones comprises an in-vehicle microphone arranged at each of at least two of a roof, an instrument panel, an A-pillar, a B-pillar, and a C-pillar of the vehicle body.

20. The vehicle according to claim 18, wherein the one or more in-vehicle microphones comprises a plurality of in-vehicle microphones arranged in an array at each of at least two of a roof, an instrument panel, an A-pillar, a B-pillar, and a C-pillar of the vehicle body.
